(19) United States
(12) Patent Application Publication
(10) Pub. No.: US 2015/0356635 A1
(43) Pub. Date: Dec. 10, 2015

(54) METHOD FOR OPTIMIZING ASSET VALUE BASED ON DRIVER ACCELERATION AND BRAKING BEHAVIOR

(71) Applicant: Rochester Institute of Technology, Rochester, NY (US)

(72) Inventor: Michael Thurston, Penfield, NY (US)

(21) Appl. No.: 14/720,006

(22) Filed: May 22, 2015

Related U.S. Application Data
(60) Provisional application No. 62/002,385, filed on May 23, 2014.

(51) Int. Cl. G06Q 30/02; B60Q 9/00

(52) U.S. Cl. CPC G06Q 30/0278; B60Q 9/00

(57) ABSTRACT

Systems and methods for optimizing asset value based on driver acceleration and braking behavior are described. The methods include collecting vehicle data, applying a weighting function to the collected data to generate a value representing the energy or fuel wasted due to acceleration and braking behavior, and tabulating the generated value over the duration of a driving event to generate a driver performance score. The methods also include evaluating the driver performance score based on a business model, and modifying subsequent driver behavior based upon the evaluation.

### CROSS REFERENCE TO RELATED APPLICATIONS

This application claims priority to U.S. Provisional application Ser. No. 62/002,385 entitled Method for Optimizing Asset Value Based On Driver Acceleration and Braking Behavior, filed on May 23, 2014, the contents of which are incorporated fully herein by reference.

### STATEMENT REGARDING FEDERALLY SPONSORED RESEARCH

Aspects of this invention were made with government support under contract number N00014-07-1-0823, Oracle Project No. 32015 awarded by the U.S. Office of Naval Research. The U.S. government has rights in this invention.

### FIELD OF THE INVENTION

The present invention relates to a method for optimizing asset value based on driver acceleration and braking behavior, and in particular to a method for optimizing asset value based on driver acceleration and braking behavior capable of modifying subsequent driver behavior.

### BACKGROUND

Driver behavior can have a significant impact on vehicle fuel economy. In heavy trucks, excessive and extended idling, extended operation at high vehicle speed, over-revving the engine during shifting, and hard acceleration and hard braking can all impact vehicle fuel economy as represented in gallons of fuel used per mile traveled, or conversely vehicle miles/gallon.

In order to manage fuel consumption in commercial fleets (including trucking, transit, etc.) metrics are needed to track vehicle characteristics that affect fuel consumption, as well as driver behaviors. The art lacks improved metrics for tracking and managing driver behavior. Given a set of good metrics, driver behavior can be modified via real-time feedback and/or more targeted driver supervision or training.

Hard acceleration and hard braking are difficult behaviors to monitor and quantify. At times hard braking is required in order to safely operate a vehicle, and if not operating outside of peak engine efficiency bands then hard acceleration is not a direct waste of energy, but simply conversion from chemical potential to kiptic energy. The art lacks a means of quantifying wasteful acceleration and braking behaviors from a fuel economy perspective.

### SUMMARY

In accordance with one aspect of the present invention, there is provided a method for optimizing asset value based on driver acceleration and braking behavior. The method includes collecting vehicle data, applying a weighting function to the collected data to generate a value representing the energy or fuel wasted due to acceleration and braking behavior, and tabulating the generated value over the duration of a driving event to generate a driver performance score. The method also includes evaluating the driver performance score based on a business model, and modifying subsequent driver behavior based upon the evaluation.

Aspects of the invention include further methods for optimizing asset value based on driver acceleration and breaking behavior. The method includes collecting braking and accelerating data from a vehicle, applying a weighting function to the collected data to generate a value representing the energy of fuel wasted due to braking and accelerating behavior by an operator of the vehicle, and determining a penalty for the braking and accelerating behavior by the operator of the vehicle from the generated value. The method also includes alerting the operator of the vehicle as to a determined penalty for the braking and accelerating behavior by the operator, where the operator is alerted as to the determined penalty at a predetermined time following the braking and accelerating behavior that caused the determined penalty.

### BRIEF DESCRIPTION OF THE DRAWINGS

The invention is best understood from the following detailed description when read in connection with the accompanying drawings, with like elements having the same reference numerals. Included in the drawings are the following figures:

FIG. 1 is a diagram representing the forces on a vehicle that result in the dissipation of energy;

FIGS. 2A and 2B illustrate a hypothetical vehicle speed profile, including acceleration and deceleration and shows how a weighting function could be defined for penalizing braking activity at time “t” which dissipates energy expended in acceleration at time “t₀”;

FIG. 3 is a graph depicting a hyperbolic function, that could also have a constant scale factor (λ=k/τ) or power relationship (λ=k/τⁿ);

FIG. 4 is a graph depicting an exponential decay, which has a unity value at τ=0; this could also be scaled (ζ=ke^{-aτ});

FIGS. 5A and 5B are graphs showing a linear weighting function, as well as a uniform weighting function. The different classes of weighting functions allow for different fleet operations managers to customize the way that they assess driver acceleration and braking behavior;

FIGS. 6A and 6B depict a chart and algorithm showing a particular way of implementing an algorithm to calculate a proposed Driver Acceleration and Braking Metric (DABM) based on the actual energy dissipated in braking. This approach assumes that a single value of DABM will be computed over some particular time range (for example a trip, or a deceleration cycle). If the DABM is calculated over a shorter time range and then stored along with a time reference value, the braking behavior could be analyzed with more resolution. This would allow for more detailed analysis of driver behavior, for example is a particular driver more likely to have a poor braking score (relative to other drivers) in highway conditions or in city or heavy traffic;

FIG. 7 is a graph illustrating how the expected “Plan Ahead Distance” for a driver might be defined as a function of vehicle speed. A plan ahead function can be defined by the fleet operations manager, and can then be used to determine the effective time constant of the weighting function. The plan ahead function could also be adjusted by weather or time of day (visibility), or based upon road curvature or topography and real-time GPS data;

FIGS. 8A and 8B depict a chart and an algorithm as an alternate way to determine energy dissipated due to braking, and utilizes the fuel consumed during acceleration in the calculation. This revised metric could also be calculated over a relatively short time frame for more detailed analysis;

FIGS. 9A and 9B are graphs showing speed profile and acceleration profile that illustrate driver behavior in accordance with aspects of the invention; and

FIGS. 10A, 10B, 10C, and 10D are graphs of velocity versus time for a first trip, a second trip, a third trip, and a fourth trip, respectively in accordance with aspects of the present invention.

### DETAILED DESCRIPTION

The present invention relates to a method for optimizing asset value based on driver acceleration and braking behavior, including collecting vehicle operation data; collecting vehicle context data; collecting external operating condition data; applying a weighting function to the collected vehicle operation and external operating condition data to generate a value representing the energy or fuel wasted due to acceleration and braking behavior; tabulating the generated value over the duration of a driving event to generate a driver performance score; evaluating the driver performance score based on a business model; and modifying subsequent driver behavior based upon the evaluation. Aspects of the invention may be used to identify and correct wasteful driving patterns such as vehicle acceleration closely followed by deceleration (speed-up, slow-down, etc.), which is wasteful of fuel due to energy dissipated in brakes, for example. Such driving patterns may also be indicative of unsafe, close-following driving.

The methods and algorithms described herein may be implemented on a system that includes one or more of at least one processor, at least one memory storage device that stores programmed instructions for one or more aspects of the present invention, at least one interface system or device (e.g., for gathering information from a vehicle), at least one user input device, and/or at least one display device which may be coupled together by a system bus or other link.

Acceleration and braking behavior can directly affect vehicle fuel efficiency performance. Acceleration and braking behavior can also be representative of unsafe driving behaviors such as following too closely in heavy traffic which may require frequent braking. As an example of a potential business model to incentivize safer and more fuel efficient behavior, drivers could be provided a monthly bonus payment as percentage of the calculated fuel savings relative to the average fleet driver performance in highway and city driving conditions.

Vehicle operation data is collected on a periodic basis from either the existing vehicle data bus, from sensors added to the vehicle, or from a combination of both. Vehicle operation data includes the following minimum information: vehicle speed, and a braking indication. If the fuel rate based algorithm is used, a signal that can be directly related to fuel consumption is also required. Other vehicle operation data that may be useful include: GPS position and attitude, throttle position, multi-axis vehicle acceleration data, and engine torque (or power), and tire air pressure.

Vehicle context data may be collected or verified on a per trip basis. Vehicle context data may include overall vehicle weight, tire data or rolling resistance estimates, and aerodynamic configuration or drag estimates (including driving vehicle and towed components).

External context data may be collected, either through use of sensors or through other information services, such as internet services. External operating condition data includes the following: weather information (in particular wind speed and direction), visibility information, light levels, road conditions, and traffic information. This information may be used directly by the algorithm to dynamically adjust coefficients or weighting functions, or it may be used later as contextual information when the driver behavior is analyzed.

Data is consolidated for analysis either on the vehicle in real-time, or with appropriate communication networks, it can be done on a server remote from the vehicle in near real-time, or as a post-processing operation. In some cases context information may be stored in other computer systems and other business applications, requiring that the data be collected to support the analysis, preferably through an automated process. This can still be done in real-time if the appropriate communication to the vehicle is in-place.

The processing algorithm uses vehicle operation data, and may use vehicle context data or external context data to generate a Driver Acceleration and Braking Metric (DABM) which provides an assessment of energy lost due to braking, this represents a loss in kinetic energy of the vehicle due to an earlier use of stored potential energy (usually chemical fuel, but also could be other forms of energy in systems with other energy storage mechanisms, such as hybrid electric vehicles) to accelerate the vehicle. Two different methods of estimating the energy loss are provided. One method estimates the actual loss in kinetic energy due to braking forces during the braking event, this requires that other energy dissipation mechanisms such as aerodynamic drag and rolling resistance be accounted for. During a braking event, over a particular sampling period (on the order of approximately 1 second), the vehicle velocity is sampled, and the braking energy is calculated. The algorithm searches through stored data for the last acceleration event at the same average velocity level. The time difference between these two sample data points represents the time between acceleration (and energy consumption) and braking (energy dissipation) and is the basis of the weighting function. Different functional forms of the weighting function are suggested, providing flexibility for calculation of the DABM. The value of the weighting function depends on the time difference between braking and acceleration events, and is applied as a scale factor to the calculated braking energy. A scale value of unity (1.0) will result in a weighted braking metric value equal to the energy dissipated, a scale value greater than unity will more heavily weight the energy dissipated. At some value of the time difference, the weighting function will be zero (or essentially zero) and the weighted energy dissipation will also be zero. The interpretation of the DABM, is that the driver is expected to watch traffic conditions far enough ahead that the acceleration behavior can be moderated so that energy dissipation due to braking can be minimized. The hyperbolic, exponential, and linear models of the weighting function more heavily penalize braking events that closely follow acceleration events. If the braking energy form of the algorithm is used, the metric is an indirect indication of excess fuel consumption due to acceleration and braking patterns, and also provides an indication of excess braking effort (which relates to brake wear) due to driving patterns.

A different form of the weighting function may be preferred by different fleet operators, or in different driving types or driving scenarios. A weighting function value of 1 provides a penalty equal to the braking energy or expended fuel for a particular acceleration instance. A weighting value higher than 1 provides a penalty larger than the braking energy or expended fuel for a particular acceleration instance. A weighting value less than 1 provides a penalty which is a fraction of the braking energy or expended fuel for a particular acceleration instance.

The hyperbolic function provides a very large penalty for braking events which closely follow acceleration events but does not require as much planning ahead. The uniform function provides a fixed penalty for any braking event that follows acceleration within the time period of the weighting function. The linear function more heavily penalizes braking events that closely follow acceleration. The exponential provides a large penalty for braking events that closely follow acceleration with a lower penalty for failure to plan ahead than the linear function. The uniform weighting function enforces the most stringent plan ahead requirement as it penalizes the driver equally for not planning ahead over the entire weighting period. Multiple weighting functions could also be applied to the data to provide two different acceleration/braking metrics. An exponential or hyperbolic function could be used as a safety metric that would capture close following and the associated safety issues. The uniform weighting function provides a better metric for incentivizing long term planning of acceleration behavior and requires a greater plan ahead in order to score well.

Other forms of the algorithm are also suggested. Instead of using energy dissipated directly due to braking forces as the basis of the DABM, if fuel rate data is available, the fuel used during the acceleration event can be used. If this method is used, the metric may be more directly related to business value (cost of fuel wasted). The first two forms of the metric only accrue energy dissipation during braking events, energy that is dissipated during coast-down events is not included in the calculation of DABM value. The algorithm could be reformulated to be applied to any deceleration event, regardless of if the brakes are applied. This formulation would focus more on acceleration behavior, independent of braking, and it is judged to produce a less preferred metric for assessing overall driver behavior.

The DABM value can be stored with a time stamp, for the particular time interval that it was calculated for. This time stamped data would allow patterns of behavior to be more fully analyzed against contextual information such as traffic loads, road type, weather condition, etc. The DABM value can also be summed up over a longer period of time, a trip, a week, a month (etc.) and used as an overall indicator of driver behavior. It may also be useful to calculate an overall (summed) DABM value for different types of driving conditions. Over any time period of consideration, the DABM value can also be compared to total braking energy, or total fuel consumed (depending on which form is used) to generate a relative (percentage) value. The fleet operations manager may select a weighting function for their operation with the expectation that the driver's DABM percentage scores will trend towards zero as drivers improve their behavior.

The DABM metric could be used in conjunction with a driver improvement program that includes other fuel economy and safety related metrics. Good and actionable metrics are key components of these types of programs. The DABM metric can be evaluated on a weekly or monthly basis and compared to fleet averages across multiple drivers. The fuel based metrics can be directly tied to fuel cost impacts of individual driver behaviors. For individual drivers, improvement targets can be set based on meeting overall fleet expectations or based on improvement of individual metrics. Targets can be used as part of the performance evaluation criteria for professional drivers, and can further be used in decisions about compensation or as a basis for incentives.

If the metrics are calculated on the vehicle, the system can also be used to provide semi real-time feedback on performance using audible cueing. From a safety standpoint, it is recommended that any feedback be provided after a braking event is completed or even during subsequent acceleration, rather than during the braking event. If excess braking is required, it is usually due to aggressive acceleration behavior or failure to maintain appropriate following distance.

For cases of very aggressive driving, it is likely that there will be more events of hard (or severe) braking. Using on-board accelerometers, or rate of deceleration (from the velocity profile), a hard braking threshold could be set. A hard braking DABM metric could then be calculated which penalizes drivers only for cases in which braking exceeds the threshold.

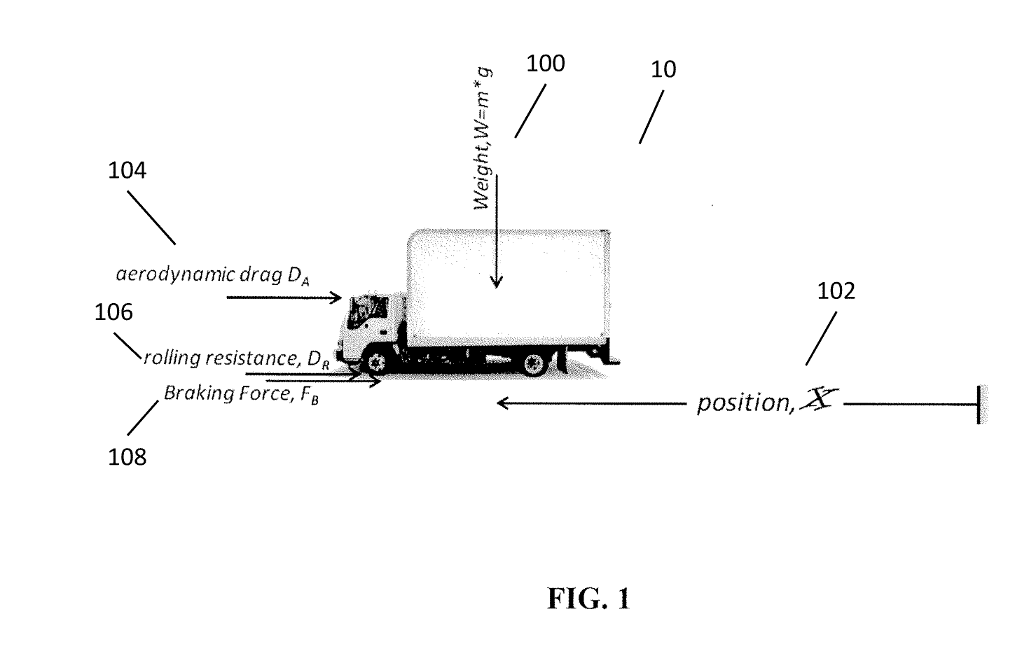

As illustrated in FIG. 1, the force to propel the vehicle 10 (F_{P}) is a function of various physical factors. The factors include the weight 100 of the vehicle 10, the position 102 of the vehicle 10 (with respect to, for example, an initial position or desired stopping/accelerating position), the drag forces 104, the rolling resistance forces 106, braking 108 forces, and the acceleration rate of the vehicle 10.

F_{P}=D_{A}+D_{R}+F_{B}+m·\ddot{X}

Using formulations for rolling resistance and aerodynamic drag (drag coefficients: CA, aerodynamic drag coeff; CR, Rolling Resistance Coeff), assuming no wind:

F_{P}=m·\ddot{X}+0.5·C_{A}\dot{X}²+C_{R}m·g+F_{B}

where \ddot{X} represents vehicle acceleration and \dot{X} represents vehicle velocity (speed). The power required to propel the vehicle (P_{P}) is a function of the propelling force and the vehicle velocity.

P_{P}=F_{P}·\dot{X}=m·\ddot{X}·\dot{X}+0.5·C_{A}\dot{X}³+C_{R}·m·g·\dot{X}+F_{B}·\dot{X}

The net energy requirement to propel a vehicle over a trip profile is the integral of the power.

E_{P}=∫P_{P}·dt=·∫F_{P}·\dot{X}·dt=∫(m·\ddot{X}·\dot{X}+0.5·C_{A}\dot{X}³+C_{R}·m·g·\dot{X}+F_{B}·\dot{X})·dt

ΔKineticEnergy=∫m·\ddot{X}·\dot{X}·dt

EnergyLostDueToDrag=∫(0.5·C_{A}\dot{X}³+C_{R}·m·g·\dot{X})·dt

EnergyLostToBraking=∫F_{P}·\dot{X}·dt

Vehicle fuel consumption is directly related to the Energy required to propel the vehicle, drive train efficiency, and engine efficiency. The model parameters in the above energy equation may be measured or in some cases directly estimated analytically. Vehicle mass can be directly determined from vehicle and cargo weight, if that information is available. If this is not possible, a system identification model may be used to estimate the parameters from operational data. Speed data is typically available from a vehicle data bus, along with an estimate of engine torque (or power). With an estimate of drive train losses, the parameters in the equation above may be estimated.

Braking force is not generally known, however if the other vehicle model parameters have been identified then braking force can be estimated. Assuming that the engine supplied power is negligible (E_{P}^{˜}0) when the vehicle's brakes are applied, the relation between braking force (F_{B}) and vehicle motion is given by:

F_{B}=−m·\ddot{X}−0.5·C_{A}\dot{X}²−C_{R}·m·g

The power loss associated with braking is given by:

P_{B}=F_{B}·\dot{X}=−(m·\ddot{X}+0.5·C_{A}\dot{X}²+C_{R}·m·g)·\dot{X}

The energy loss due to braking can then be estimated from:

E_{B}=∫F_{B}·\dot{X}·dt=∫−(m·\ddot{X}+0.5·C_{A}\dot{X}²+C_{R}·m·g)·\dot{X}·dt

During heavy braking events, particularly at lower vehicle speeds, the braking force term is much larger than the aerodynamic and rolling drag components of vehicle energy loss. In this case, the energy lost due to braking can be estimated from:

E_{B}≈−∫m·\ddot{X}·\dot{X}·dt,

which is equivalent to lost kinetic energy due to braking related deceleration.

Over the course of a vehicle trip, the overall energy consumption is driven by losses due to: mechanical friction, rolling resistance, aerodynamic drag, and braking.

Assuming that the relationship between Fuel Consumption and vehicle energy demand is known (FC=G(E_{P})), the fuel that must be consumed to overcome losses associated with braking (FC_{B}), can be estimated.

FC_{B}=G(E_{B})

FC_{B} is useful for aiding in comparison of trip to trip energy consumption, allowing for normalization of braking losses. It also provides some sensitivity to driver to driver variation. However, in the simple energy model all braking events are treated equally. For the purposes of driver behavior comparison, it is useful to consider different metrics that more heavily penalize unsteady (speed-up, slow-down) driver behaviors.

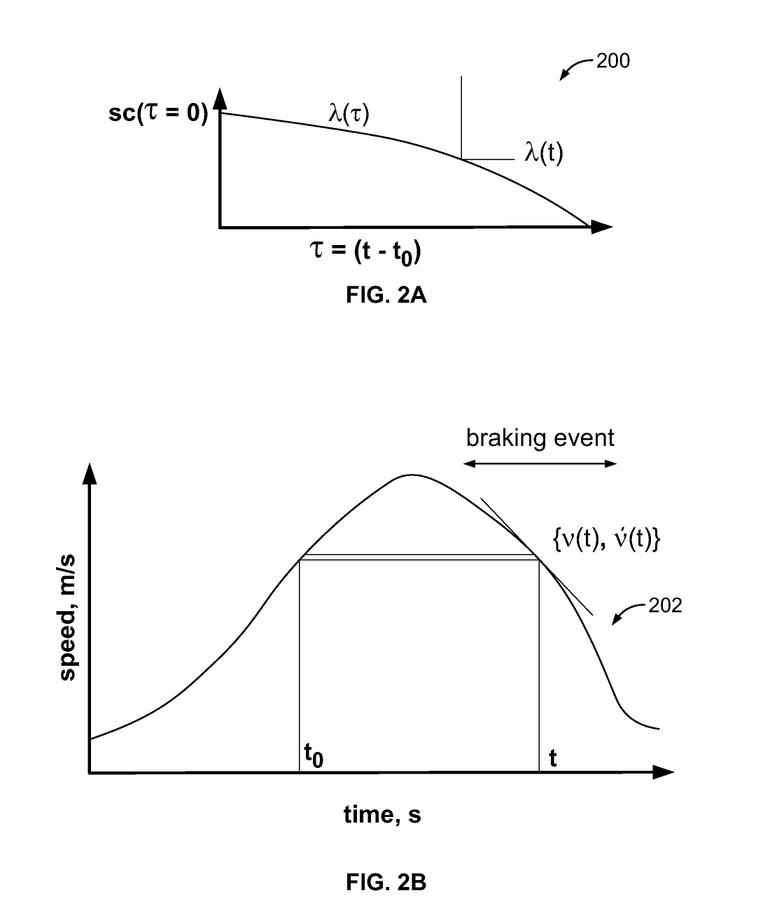

A few different metrics for comparing driver acceleration/braking behavior have been developed, illustrated in FIGS. 2A and 2B. Both concepts use the idea that, while braking, the braking energy losses are normalized based upon the amount of time since the vehicle last accelerated to the same speed. For each braking instance (over a particular small time delta) the current speed is noted. The data is checked to look for the last time that the same speed value was achieved. The energy or fuel use associated with acceleration at this earlier point of time is potentially “wasted acceleration”. The weighting function is applied to the energy or fuel use value from the earlier acceleration to generate an energy or fuel use value for the current braking instance. The “wasted” energy or fuel value, which is the weighting function scaled value, can be accumulated over a trip (or other time period) to determine the total wasted energy or fuel over that time period.

FIG. 2A is a graph 200 illustrating a general form of the weighting function. FIG. 2B is a graph 202 illustrating a speed profile for the vehicle. In FIG. 2B at time “t” the vehicle is braking. FIG. 2B indicates that the last time that the vehicle speed was the same as at time “t” was at time “to”. The value of the weighting function is therefore calculated as τ(t−to). The weighting function is applied to the either the braking power/energy at time “t” or to the fuel consumed in acceleration at time “to” to determine the DABM value for the time “t.” As noted above, the DABM value at time “t” can be added to previous values to determine a total trip value for DABM up to time “t.”

Two primary concepts are suitable. The first concept shown in graph 200 of FIG. 2A uses a predefined function (λ), which is a function of the time (τ) the last acceleration through the same velocity value. For every time step at which braking occurs, the current velocity is noted and the vehicle speed history inspected to look for the last time at which the same velocity value occurred. The difference in the current time and the time at which the same velocity last occurred is entered into the weighting function to determine the weighting value to apply to either the braking energy at the current time or to the fuel consumed in accelerating the vehicle at the last matching speed/velocity value. In the simplest form, λ is a function of the time variable (τ) only. It is also possible to define a function λ(r,v) which is a function of the time variable and velocity. This allows for a different weighting function at different vehicle speeds, since there is more stop and go at low vehicle speeds, the acceleration/braking penalties might be designed to be lower. The weighting function decreases the weight applied to the braking energy losses the longer that the vehicle has maintained the current speed. Any functional form can be used for λ, however the basic idea is braking that closely follows acceleration indicates that the energy consumption associated with the acceleration was wasted. The Driver Braking Metrics described herein were developed to provide a measure of wasteful patterns of acceleration and braking. FIG. 2B represents a speed profile that illustrates how during a braking event, the last time that the vehicle was operating at the same speed can be determined. The time between these two time instances determines the value of the weighting function.

Braking Power, P_{B}(t)=PF_{B}(t)=−(m·\dot{v}(t)+0.5·C_{A}v(t)²+C_{R}·m·g)·v(t),

, when vehicle is not braking.

In the simplified form:

P_{B}(t)=−m·\dot{v}(t)

DriverBrakingMetric(1), DBM^{E}=∫ₜᵣᵢₚλ(t)·P_{B}(t)·dt, or DBM₁=∫ₜᵣᵢₚλ(t,v)·P_{B}(t)·dt

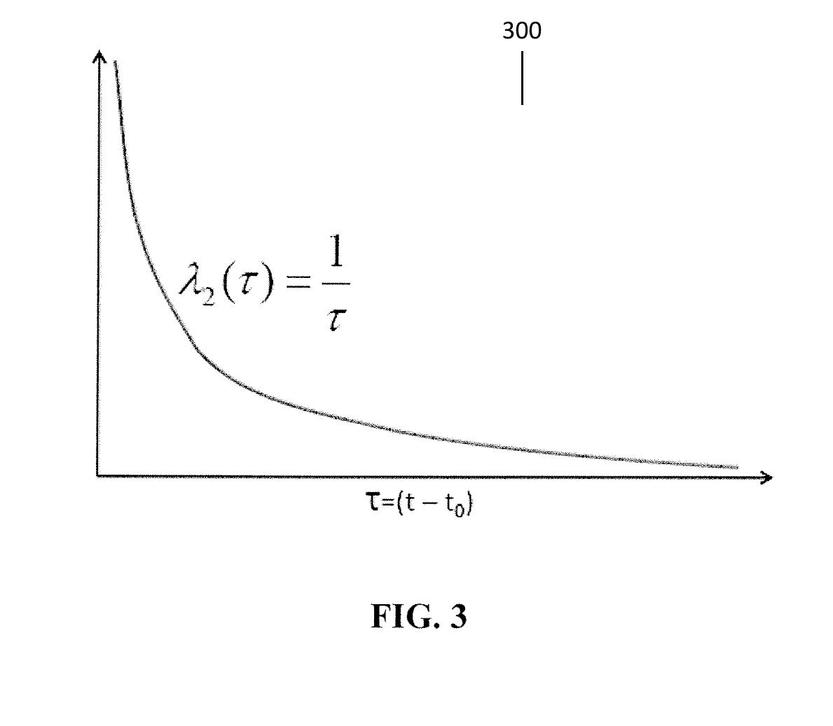

Several functional forms for the weighting function are discussed below. FIG. 3 is a graph 300 showing the difference in the current deceleration time and the time of last acceleration as the scale factor.

$$\begin{matrix}DriverBrakingMetric ( 2 ) , {DBM}^{E} = {\int }_{trip} {λ}_{2} ( t - {t}_{0} ) \cdot {P}_{B} ( t ) \cdot d t , or {DBM}_{1} \\ = {\int }_{trip} \frac{1}{( t - {t}_{0} )} \cdot {P}_{B} ( t ) \cdot d t\end{matrix}$$

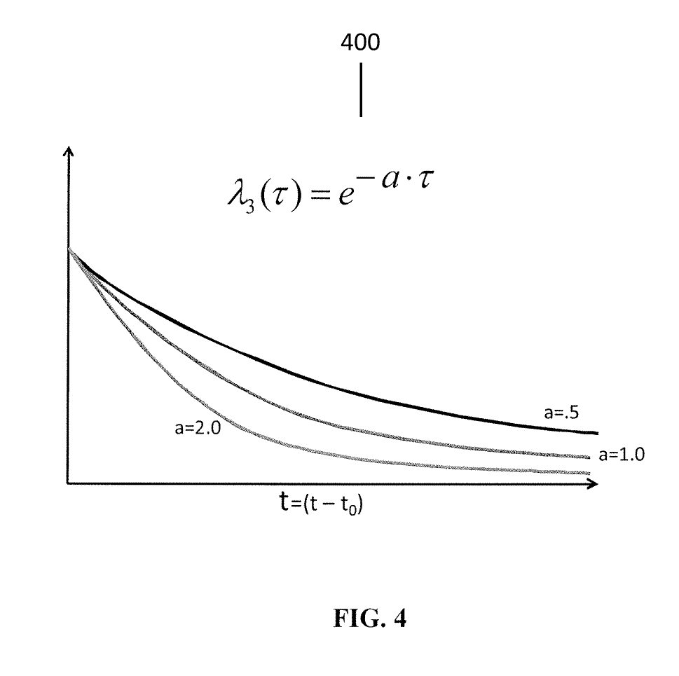

Conceptual advantages of the λ₂ form are: no a-priori knowledge/decision is required, and it imposes a significantly greater penalty on braking which follows closely after acceleration. Another convenient form for λ, is λ=k*exp(−a*τ). This function produces a series of weighting factor curves that start at a value of k (for which k=1.0 is a useful choice), and decay to zero over time, as is shown in the graph 400 depicted in FIG. 4.

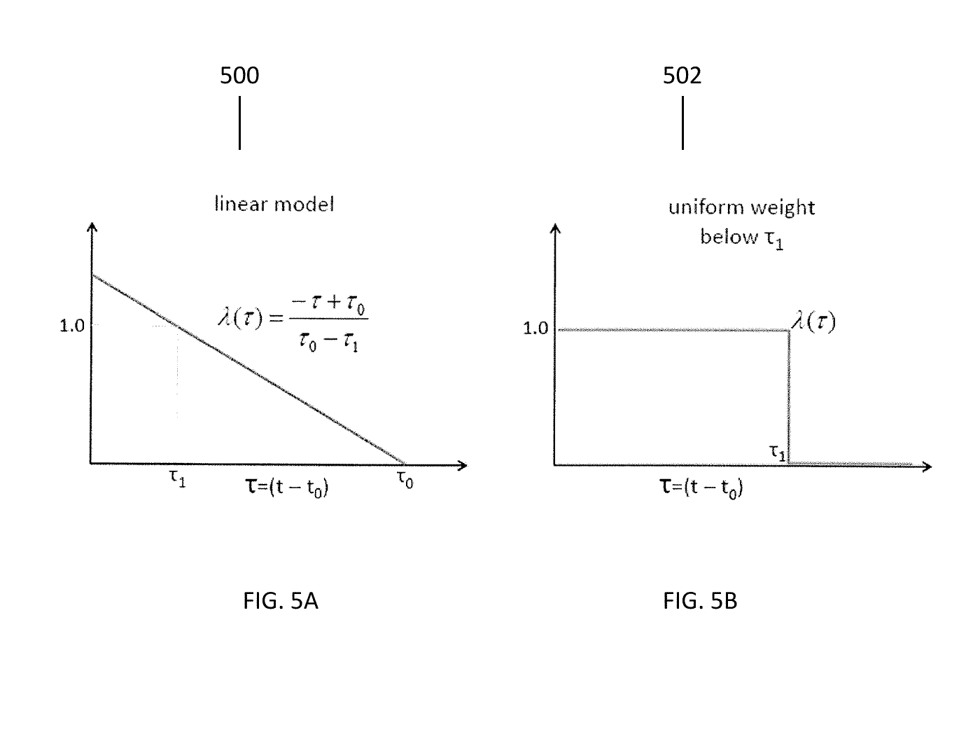

A few other useful functional forms are depicted in FIGS. 5A and 5B. The linear model 500 accentuates braking events that occur within τl of acceleration events and attenuates braking events that occur more than τl after acceleration. Using the “uniform below τl model” 502, the output represents the total braking energy that occurs within τl of an acceleration event.

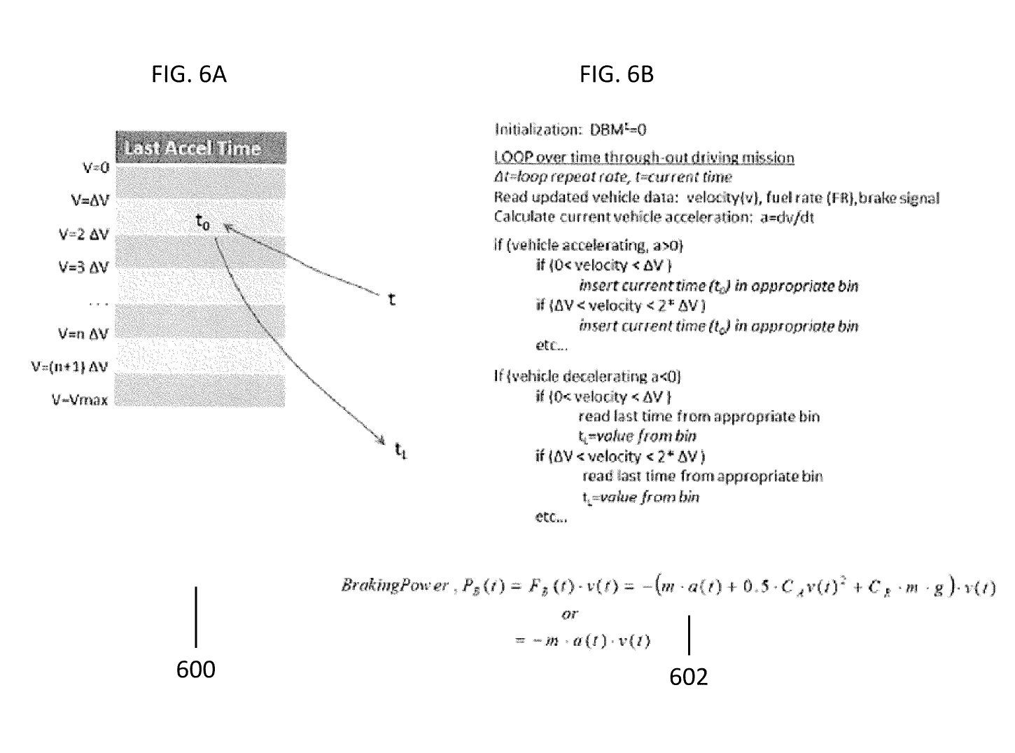

One way to implement this approach is to discretize the vehicle velocity range into velocity bins, and then operate on these velocity bins. An implementation concept is shown in the chart 600 and algorithm 602 of FIGS. 6A and 6B. The weighting function is defined in terms of time, it can alternatively be defined in terms of distance traveled. When accelerating through a particular speed, the trip distance would be stored. When subsequently decelerating through that same speed, the earlier stored distance would be used in the weighting function to weight the energy lost through braking.

As noted above, several different functional forms are proposed for the weighting function, including: inverse function, exponential decay, linear decay, and rectangular. The amplitude of the weighting function could be a function of vehicle velocity, and similarly that the shape of the weighting function could be a function of vehicle velocity.

Presented below are several different suggested ways of determining an appropriate weighting function shape and scale. A “characteristic decay time” CDT can be defined for each of these functions such that the weighting function has decayed to some small fraction of unity, for example 0.10 (or 10%). For each functional form, adjusting the functional parameters can adjust the effective CDT of the weighting function. It may be desirable to continually adjust the weighting function CDT based on the current vehicle speed and other contextual information.

Distance Look Ahead: The fleet operator may determine at different vehicle speeds that the driver should be adjusting current driving behavior to a particular “plan ahead distance” (PAD). The recommended form of the PAD is a function of vehicle velocity. At a higher speed, the driver should be planning ahead for a longer distance to brake. The PAD function may be therefore defined for different fleet operators or for different types of trucks or cargo in order to represent the desired plan ahead distance at a particular speed. Given a PAD function, the associated CDT can be determined from vehicle speed (CDT=PAD/V).

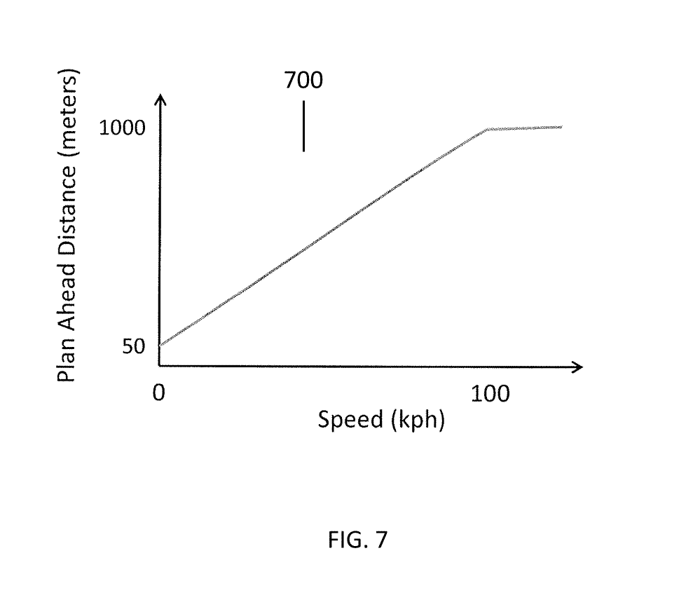

A particular PAD function 700 is illustrated in FIG. 7. The PAD may need to be adjusted based on time of day, or weather or road conditions. Driving visibility is limited at night and therefore the Plan Ahead Distance may be limited based on models of lighting conditions at a particular time of day. The PAD for nighttime driving may be limited to 500 m (or other selected distance based on headlight range) at highway speeds. Weather or visibility data may also be directly available from internet services. This data could be updated dynamically and used to adjust the desired PAD that is used to determine the appropriate CDT. Additionally, GIS (geographic information system) road data can be used to estimate the effective look-ahead distance at a particular time. If a vehicle is going up a hill, or entering a turn, the look-ahead distance may be limited and therefore it may be desirable to also limit the anticipated PAD. If a vehicle is going down a hill on a straight road it may be appropriate to increase the PAD distance. GIS data can also identify whether a particular road is rural or urban, highway or secondary road, and real time traffic systems can provide current traffic loading data. In rural areas it may be appropriate to increase the PAD for lower speeds and conversely for urban streets. During times of high traffic loads it may be appropriate to reduce the amplitude of the weight function, or reduce the PAD distance for lower driving speeds. In heavy traffic situations it may also be more appropriate to use a decaying weight function as opposed to a rectangular function.

The proposed system provides a flexible framework for adapting the braking penalty functions to the needs of a particular fleet operator. Other embodiments of the idea could be implemented for cases where the vehicle mass and other vehicle model parameters are not available or cannot be determined. The m*a(t)*v(t) form for braking power could be used, with a unit (or fixed nominal) value of mass used instead of the actual mass. This would result in a metric that operates directly on the vehicle motion (and driver control) profile, independent of the additional impact of vehicle mass on fuel economy.

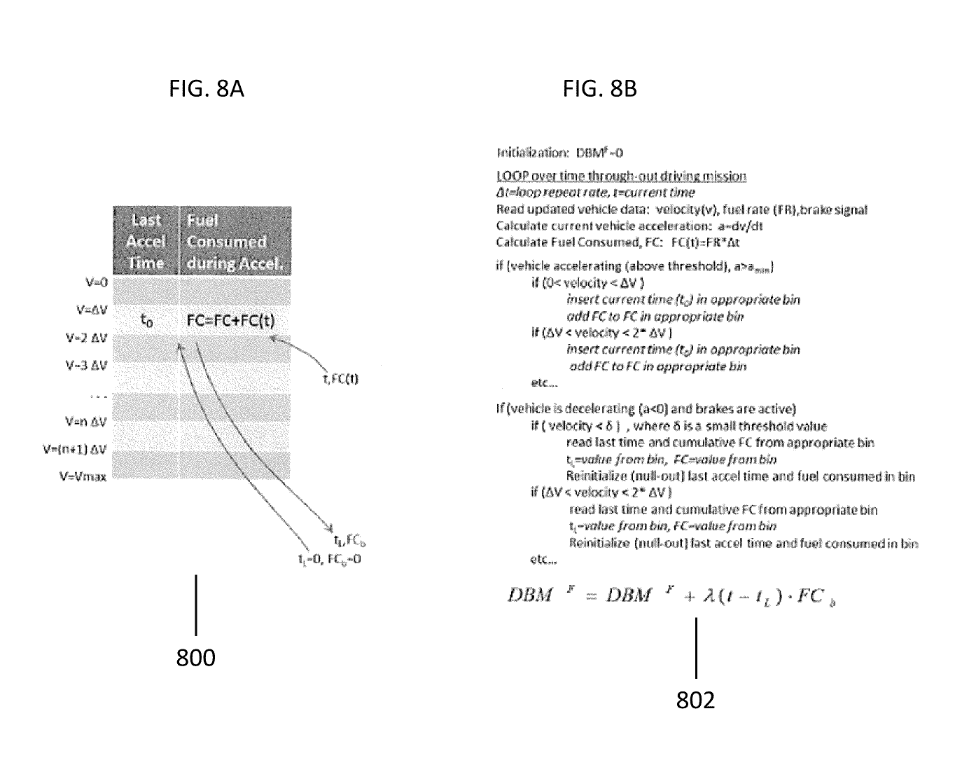

A further embodiment uses fuel consumption directly. In this case, fuel consumption during acceleration periods would be tracked and accumulated directly and binned by vehicle speed (similar to above). Use of a minimum acceleration threshold is useful to prevent noise in the acceleration data from causing improper transitions back and forth between acceleration and deceleration states when the vehicle is operating at a constant speed or with a very small acceleration value. During a confirmed acceleration event, the “Fuel Consumed During Acceleration” is accumulated for each defined speed band. This method is particularly useful if the vehicle mass or the vehicle parameters required to estimate drag and rolling friction losses are not well known. When a braking event occurs, the time of the braking event and the time of the last acceleration event (“Last Accel Time”) are used to estimate the value of the weighting function. In the chart 800 and algorithm 802 shown in FIGS. 8A and 8B, fuel consumption as scaled by the weighting function is allocated to the braking process (and the “Driver Braking Metric” updated) when the brakes are engaged, the vehicle is decelerating, and the vehicle decelerates below the lower bin threshold.

As with the energy based DABM, the fuel consumption based DABM can use arbitrary forms of the weighting function, including velocity dependent weights. The weighting function can also be defined in terms of “miles driven since velocity threshold was achieved” instead of “time since velocity threshold was achieved.”

One use of these metrics is for off-line monitoring and retraining of driver behavior, rather than for real-time driver feedback. Negative feedback during or following braking actions may give the driver negative reinforcement about braking and lead to safety concerns. A goal of the DABMs is to modify acceleration behavior (don't accelerate to high speed if traffic patterns ahead do not provide head room for higher speed) and close following which can also result in frequent application of brakes (and loss of vehicle energy) followed by re-acceleration to speed (which takes additional investment of fuel).

An application for real-time use of the DABM is in heavy traffic situations. From a fuel economy standpoint, a steady driving speed will generally be more efficient than frequent speeding up and slowing down. If there is a repeated sequence of wasteful braking instances within a defined time frame, an alert (audio or visual) could be provided to the driver on a subsequent acceleration that falls within a defined time frame and exceeds some defined acceleration or speed threshold. The recent speed history could be used to identify appropriate time frames or thresholds for alerting. This approach provides feedback on the causal event rather than on the subsequent braking that becomes necessary due to aggressive acceleration.

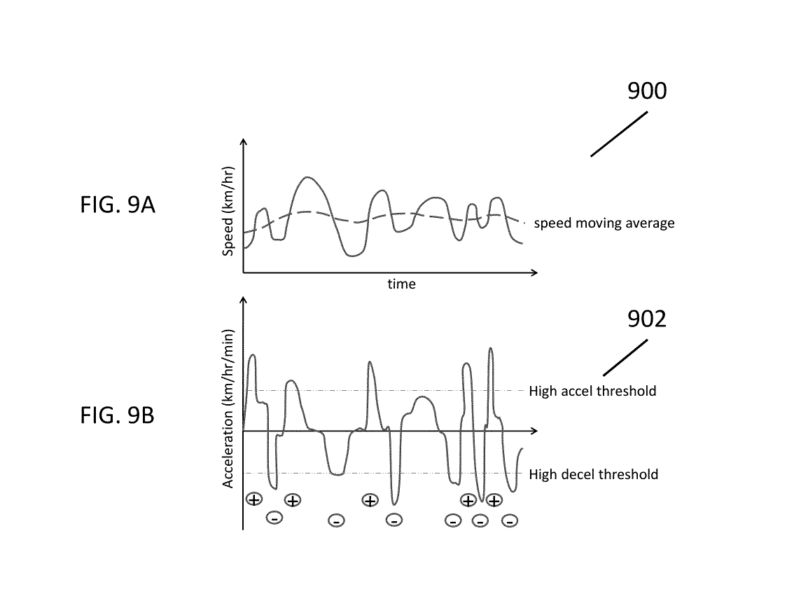

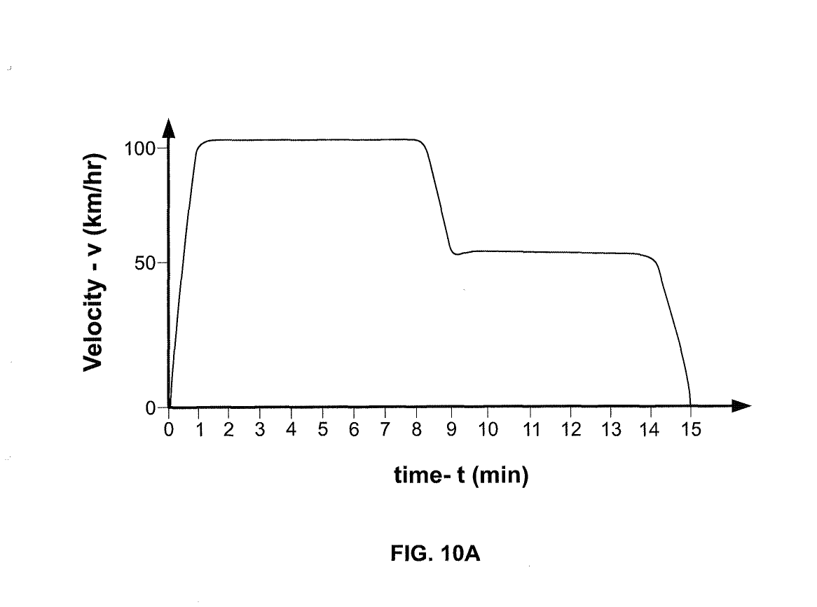

FIGS. 9A and 9B illustrate these concepts. The graph 900 shows a speed profile that illustrates unsteady driver behavior. A moving average value for the speed is overlayed on the graph 900. If the driver was better planning for traffic variations, the actual vehicle speed would more closely matched the moving average value and the fuel economy performance would be improved. The graph 902 shows the acceleration pattern that is associated with the speed pattern. Peaks in the vehicle acceleration and deceleration that exceed the noted thresholds are noted by plusses and minuses below the graph 902. The high acceleration and deceleration thresholds should be set based on a distribution of driver behavior in different driving scenarios/speeds. For example, at low speed vehicles can accelerate faster and the threshold should be higher. A highway speeds, vehicles cannot accelerate as fast and the threshold should be lower. A fleet manager could establish these appropriate levels based on a particular vehicle speed band and the characteristic distribution of values for his fleet.

A moving average can then be used to track the frequency of both high acceleration and high deceleration events. An appropriate frequency for these events could also be established based on the distribution of behavior of drivers across a fleet for different driving scenarios/speeds. If the moving average of the current drivers high acceleration and braking frequency exceeds the threshold for the current driving environment, the driver would be alerted every time his acceleration rate exceeds the current high acceleration threshold. This ultimately would lead to moderation of both hard acceleration and braking behavior and improve DABM scores while not providing feedback only on acceleration events and not on braking events (which could have negative safety implications)

The invention will be further illustrated with reference to the following specific examples. It is understood that these examples are given by way of illustration and are not meant to limit the disclosure or the claims to follow.

### EXAMPLES 1-4

Four different RPM and fuel consumption profiles and two different λ functions were used as examples of how the algorithm works. Results are shown in below in trips 1, 2, 3, and 4 (superimposed on the RPM graphs).

In the trips below, the values are identified as such.

DBM or DABM stands for the driver acceleration/braking metric that is being computed.

λ_{A} (lamda) is the weighting function, two are used in the example. “A” is the exponential form, “B” is the uniform form.

DBM(λ_{A})^{E} Superscripts describes two different forms of the metric, “E” for the energy form, “F” for the fuel form. The units show the values in KiloJoules for energy or Liters for fuel.

The DBM/DABM value represents the amount of energy or fuel that is determined to be “wasted” based on the defined weighting function. DBM(λ_{A})^{E}/E_{B}=0.1% : This is a relative form of the metric which divides the wasted energy by the total braking energy over the trip. It defines the percentage of the braking energy that is judged to be wasted due to poor acceleration and braking behavior over the time frame of analysis.

Fuel consumed is the total fuel consumed over the trip.

Distance traveled is the total trip distance.

Fuel economy is the average distance traveled per amount of fuel.

Energy consumed is the sum of energy required to accelerate the vehicle and overcome rolling and wind resistance.

Weighting functions: Weighting function B has a uniform (and unity, value=1) penalty for any braking that follows acceleration by less than 120 seconds. Weighting function A has an exponential weighting function which heavily penalize braking events that follow closely after acceleration events. For example a braking event that follows within 5 seconds of an acceleration event will generate a weighting/penalty multiplier of ˜2.76 (greater than unity). However, after 60 seconds the weighting/penalty multiplier is 1.10, and after 120 seconds is only 0.41.

$${λ}_{A} = 3 \cdot {e}^{- \frac{τ}{60}} , τ in seconds$$

$${λ}_{B} = 1 if τ \leq 120 seconds , 0 if τ > 120 seconds$$

### TRIP 1

Fuel Consumed(F)=7.09 L
Distance Traveled=19.2 km
Fuel Economy=2.70 km/L
Energy Consumed(E)=72.6 GJ
Braking Energy (E_{B})=1.83 MJ
DBM(λ_{A})^{E}=1.9 KJ DBM(λ_{A})^{E}/E_{B}=0.1%
DBM(λ_{B})^{E}=0 KJ DBM(λ_{B})^{F}/E_{B}=0%
DBM(λ_{A})^{F}=6.7 e-4 L DBM(λ_{A})^{E}/F=0.0%
DBM(λ_{B})^{F}=0 L DBM(λ_{B})^{F}/F=0%

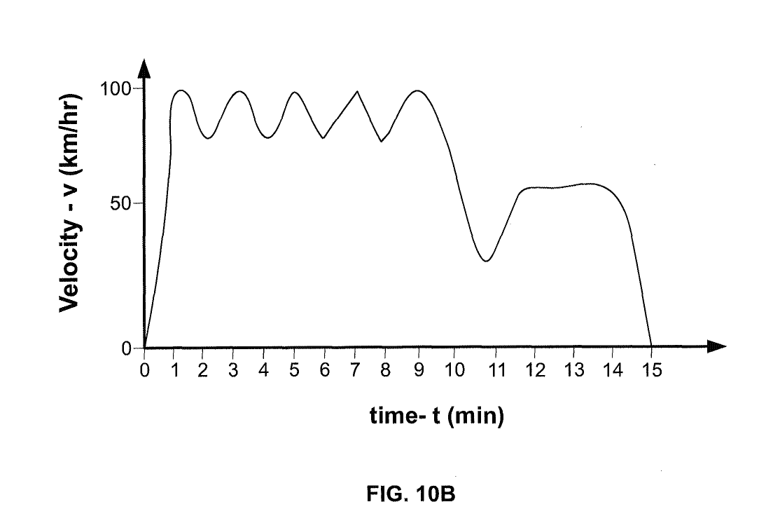

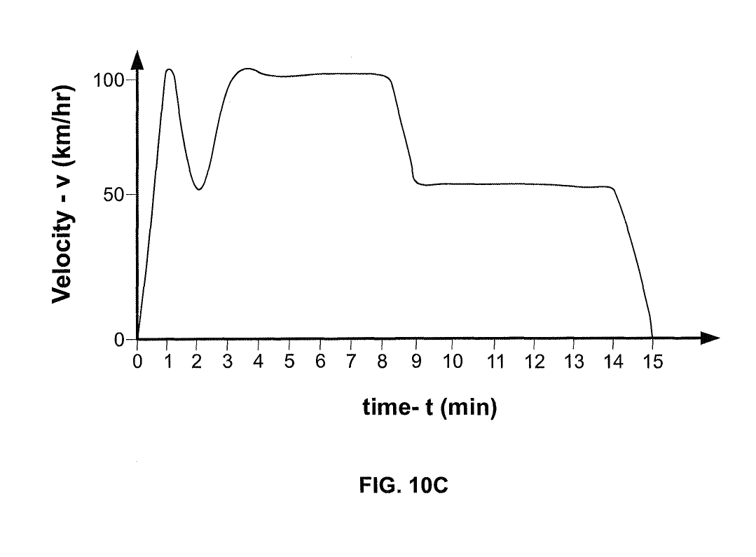

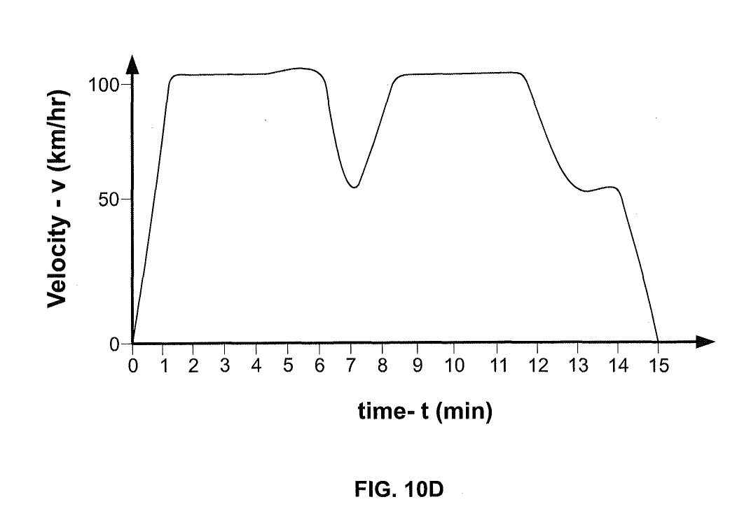

In trip 1, with reference to FIG. 10A, the driver accelerates steadily and then maintains speed before steadily braking, and maintains a moderate speed before braking to a stop. In this example the penalty function is zero (or small) at the time braking occurs and the DBM metrics show small values (minimal waste due to acceleration/braking behavior). On a percentage basis, the wasted energy and fuel is close to 0%. These are close to ideal values with respect to the driver behavior.

### TRIP 2

Fuel Consumed(F)=6.26 L
Distance Traveled=17.6 km
Fuel Economy=2.81 km/L
Energy Consumed(E)=63.3 GJ
Braking Energy (E_{B})=2.48 MJ
DBM(λ_{A})^{E}=1.1 KJ DBM(λ_{A})^{E}/E_{B}=46%
DBM(λ_{B})^{E}=0.56 MJ DBM(λ_{B})^{F}/E_{B}=23%
DBM(λ_{A})^{F}=6.33 L DBM(λ_{A})^{E}/F=101%
DBM(λ_{B})^{F}=3.15 L DBM(λ_{B})^{F}/F=50%

In trip 2, with reference to FIG. 10B, a much more inconsistent speed pattern over the first half of the data, with frequent acceleration and braking events is shown. The DABM metrics all show significantly increased values relative to trip 1. Using the uniform weight function the metric indicates that braking energy constitutes a 23% waste of energy and related to fuel this amounts to a 50% waste of fuel. The exponential weighting function provides a higher value for the metric, approximately double the uniform weighting. This is because the exponential metric (as defined) amplifies the penalty for braking shortly after an acceleration event.

### TRIP 3

Fuel Consumed(F)=6.67 L
Distance Traveled=18.3 km
Fuel Economy=2.74 km/L
Energy Consumed(E)=67.1 GJ
Braking Energy (E_{B})=2.92 MJ
DBM(λ_{A})^{E}=2.1 MJ DBM(λ_{A})^{E}/E_{B}=73%
DBM(λ_{B})^{E}=1.1 MJ DBM(λ_{B})^{F}/E_{B}=37%
DBM(λ_{A})^{F}=0.75 L DBM(λ_{A})^{E}/F=11%
DBM(A_{B})^{F}=0.35 L DBM(λ_{B})^{F}/F=5%

In trip 3, with reference to FIG. 10C, a relatively steady acceleration and braking profile is except for the initial large breaking event 1 minute into the trip is represented. The metrics show that the wasted breaking energy is a large portion of the total breaking energy. From the standpoint of fuel wasted over the entire trip, the percentages are more modest. The exponential weighting function again provides a large penalty value than the uniform function because the braking event closely follows the acceleration event.

### TRIP 4

Fuel Consumed(F)=8.26 L
Distance Traveled=21.0 km
Fuel Economy=2.54 km/L
Energy Consumed(E)=83.8 GJ
Braking Energy (E_{B})=2.92 MJ
DBM(λ_{A})^{E}=46.1 KJ DBM(λ_{A})^{E}/E_{B}=1.6%
DBM(λ_{B})^{E}=0 KJ DBM(λ_{B})^{F}/E_{B}=0%
DBM(λ_{A})^{F}=0.027 L DBM(λ_{A})^{E}/F=0.3%
DBM(λ_{B})^{F}=0 L DBM(λ_{B})^{F}/F=0%

In trip 4, with reference to FIG. 10D, fairly steady acceleration and braking profile is shown, except for the significant braking event roughly mid way through the trip, and the step at the end of the trip. All of the DABM metrics show small values for wasted energy and fuel. This case illustrates that braking followed closely by acceleration is not penalized by this methodology, whereas trip 3 shows that acceleration followed closely by braking is penalized.

The analysis of the various types of driving profiles and metrics shows that trips 1 and 4 have the lowest overall fuel economy. This is driven primarily by the fact that the average speed (and therefore travel distance) is higher for those driving profiles. The Driver Acceleration and Braking Metrics for trips 1 and 4 are significantly better than for trips 2 and 3 due to the smoother trip profiles. The percentage of total trip energy consumption that is due to braking is highest in trips 2 and 3. In addition, the Driver Acceleration and Braking Metrics for profiles 2 and 3 show that a higher percentage of the total braking energy for the trip is braking that closely follows acceleration. The DABM^{E} for λ_{B} gives directly the amount of acceleration energy that is “wasted” due to braking that follows within a 2 minute period.

The DABMs based on fuel rate measurement (DABM^{F}) do not provide as refined a view of the acceleration and braking effects. These metrics were developed for the case where the vehicle mass and other model parameters are unknown. It still provides a directional picture of driving patterns which are wasteful, however fuel use do to other effects (such as overcoming aerodynamic drag) are also included in the metric.

Although various embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed:

1. A method for optimizing asset value based on driver acceleration and braking behavior, comprising:
collecting vehicle data;
applying a weighting function to the collected data to generate a value representing the energy or fuel wasted due to acceleration and braking behavior;
tabulating the generated value over the duration of a driving event to generate a driver performance score;
evaluating the driver performance score based on a business model; and
modifying subsequent driver behavior based upon the evaluation.

2. The method of claim 1, wherein the vehicle data comprises at least one of vehicle speed, braking indication, global positioning system (GPS) position and attitude, throttle position, multi-axis vehicle acceleration data, engine torque, and tire air pressure.

3. The method of claim 1, wherein the vehicle data comprises overall at least one of vehicle weight, tire data or rolling resistance estimates, and aerodynamic configuration or drag estimates including driving vehicle and towed components.

4. The method of claim 1, wherein the vehicle data comprises at least one of weather information, including wind speed and direction, visibility information, light levels, road conditions, or traffic information.

5. The method of claim 1, wherein the value representing the energy or fuel wasted due to acceleration and braking behavior is calculated from an estimate of braking forces during a braking event.

6. The method of claim 1, wherein the value representing the energy or fuel wasted due to acceleration and braking behavior is estimated from the fuel used during an acceleration event.

7. The method of claim 1, wherein the value representing the energy or fuel wasted due to acceleration and braking behavior is calculated from an estimate of kinetic energy loss during a braking event.

8. The method of claim 1 wherein the vehicle data necessary to estimate energy loss during breaking are provided by a software interface to another business application, such as asset management or operations management systems.

9. The method of claim 1 wherein the vehicle data necessary to estimate energy loss during breaking are determined dynamically through system identification methods.

10. The method of claim 1 wherein a cargo mass of the vehicle is estimated dynamically using system identification methods and the vehicle data other than the cargo mass are provided by a software interface to another business application, such as asset management or operations management systems.

11. The method of claim 10, wherein aerodynamic drag and rolling resistance parameters are dynamically updated based on real-time data, and other available contextual information.

12. The method of claim 1, wherein acceleration and braking behavior are calculated on the vehicle in near real-time, or off the vehicle in near real-time and communicated back to the vehicle.

13. The method of claim 12 where a sequence of wasteful driver acceleration and braking metric (DABM) events exceeds a target threshold, and an alert is provided to warn the driver of a subsequent acceleration event that occurs within a time threshold and exceeds an acceleration threshold.

14. The method of claim 1, wherein acceleration and braking behavior are calculated off the vehicle after completion of a driving sequence and driver acceleration and braking metric (DABM) results used to assess a driving performance in driving conditions, or aggregated over the entire sequence to determine an overall driving performance metric.

15. The method of claim 14, wherein the driver performance is represented in units of fuel that were wasted due to a non-ideal driver behavior.

16. The method of claim 1 wherein the weighting function is a function of time since acceleration affecting how energy losses due to braking activity are accrued by a driver acceleration and braking metric (DABM).

17. The method of claim 16 wherein a functional form of the weighing function, including the characteristic delay time of the weighting function, changes depending on vehicle operating conditions or external conditions.

18. The method of claim 17, where the characteristic delay time of the weighting function is adjusted based on a plan ahead distance and the vehicle speed at the time of acceleration.

19. The method of claim 18, where the functional form of the weighting function or the plan ahead distance is also a function of one or more parameters that include at least one of real-time traffic load data, weather conditions, light conditions, road profile including slope or curvature, type of road (such as local road or limited access highway), and proximity to intersections or interchanges.

20. A method for optimizing asset value based on driver acceleration and breaking behavior, comprising:
collecting braking and accelerating data from a vehicle;
applying a weighting function to the collected data to generate a value representing the energy or fuel wasted due to braking and accelerating behavior by an operator of the vehicle;
determining a penalty for the braking and accelerating behavior by the operator of the vehicle from the generated value; and
alerting the operator of the vehicle as to a determined penalty for the braking and accelerating behavior by the operator,
wherein the operator is alerted as to the determined penalty at a predetermined time following the braking and accelerating behavior that caused the determined penalty.

21. The method of claim 20, wherein the weighting function is a function of time.

22. The method of claim 20, wherein the weighting function is a function of distance.
